(19) United States
(12) Patent Application Publication
(10) Pub. No.: US 2002/0025464 A1
(43) Pub. Date: Feb. 28, 2002

(54) Fuel cell system

(76) Inventor: Norbert Breuer, Ditzingen (DE)

Correspondence Address: Walter Ottesen, Patent Attorney, P.O. Box 4026, Gaithersburg, MD, 20885-4026, US

(21) Appl. No.: 09/911,430

(22) Filed: Jul. 25, 2001

(30) Foreign Application Priority Data
Jul. 27, 2000 (DE) 100 36 572.8

(51) Int. Cl. H01M 8/04; H01M 8/06; B60L 11/18

(52) U.S. Cl. 429/22; 429/19; 180/65.3

(57) ABSTRACT

A fuel cell system has a fuel cell unit (1) and a fuel preparation unit. A measuring unit (7, 8) is provided for measuring at least a first operating parameter of the fuel cell unit (1). The fuel cell system makes possible an almost complete monitoring of the internal operating state of the fuel cell unit (1). The number of utilized sensors (7, 8) is reduced and thereby also the complexity of the system. This is achieved in that an evaluation unit (7, 8, 9) is provided for evaluating a time-dependent change of the first operating parameter of the fuel cell unit (1) in dependence upon a known time-dependent change of at least a second operating parameter of the fuel cell system.

### FIELD OF THE INVENTION

The invention relates to a fuel cell system having a fuel cell unit and a fuel preparation unit. A measuring unit is provided for measuring at least a first operating parameter of the fuel cell unit.

### BACKGROUND OF THE INVENTION

Fuel cells are electrochemical converters of chemical energy into electrical energy. A fuel cell comprises an anode, in which a substance is electrochemically oxidized, a cathode on which a further substance is electrochemically reduced and an electrolyte which permits an ionic charge transfer between the two electrodes. As a simplification, the substance to be oxidized is referred to in the following as fuel. Correspondingly, the term “air” is referred to in the following as the reducing substance without any limitation as to the generality thereof.

Basically, a fuel cell unit can be an individual fuel cell as well as an electrical and/or electrochemical circuit of several fuel cells. In addition to the electrical circuitry, a structure is disposed in a fuel cell unit or in a fuel cell stack which serves to supply the electrodes with educts and to transport away products. In addition to the fuel cell stack, peripheral components are also part of a fuel cell system. These peripheral components are, for example, needed for the gas supply, for the heat management and for the control technology of the stack.

In conventional fuel cell systems, so-called PEM fuel cells are often used which, however, react especially to carbon monoxide components in the hydrogen-rich medium with adsorbed Co on the catalytic cathode so that the conversion of hydrogen at the electrode is made more difficult or is prevented. This CO-binding is referred to by experts generally with the term “poisoning” of the cathode. For this reason, fuel cell systems have to ensure the production of a substantially carbon monoxide free hydrogen-rich medium. Accordingly, the carbon monoxide component is almost completely reduced in the hydrogen-rich reformate with the aid of reactors.

The achievable power density, the efficiency and the service life of fuel cell units is very dependent upon their operating conditions. Relevant operating parameters are, for example, temperature, pressure, gas composition, mass flow of the supplied gas flows, the outputted electrical power and the external resistance. These operating parameters influence an internal operating state of the fuel cell unit. This internal operating state, for example, changes the structure and the surface chemistry of the catalysts as well as the temperature distribution and substance distribution of the fuel cell unit.

The mentioned dependency of the PEM fuel cell unit on the CO-concentration of the anode gas as well as the humidity of the anode gas and also the cathode gas are especially critical operating parameters which must be maintained within tight limits. For example, a humidity of the anode gas, which is too low, can lead to a drying out of the polymer electrolyte and therefore to a possibly irreparable damage of the membrane. If, on the other hand, the humidity is too high, then the pore structure of the electrodes can fill with water beyond the optimal value whereby the transfer of the educts to the catalyst of the fuel cell unit is hindered. For example, the maximum possible power of the fuel cell unit is significantly reduced by a deviation from the optimal values of the operating parameters.

For this reason, a set of operating parameters is generally determined which are monitored individually by sensors and are controlled by means of corresponding control units such as valves, pumps, storage tanks or the like. These can be arranged in the fuel preparation unit (that is, in the reformer unit including the reactor stages) connected downstream as well as in the fuel cell unit.

A great many necessary sensors, however, result from the large number of relevant operating parameters so that the complexity as well as an economic operation of corresponding fuel cell systems are disadvantageously changed.

It is known, for example, that the operating voltage of the fuel cell unit can be used to control the fuel cell system as shown in U.S. Pat. No. 5,763,113, incorporated herein by reference. Also, it is known, for example, that the operating current of the fuel cell unit can be used to control the fuel cell system as shown in U.S. Pat. No. 5,478,662, incorporated herein by reference. In these devices, it is, however, disadvantageous that these react exclusively to uncontrolled disturbances of the fuel cell unit or the fuel preparation unit. Changes of the measured and evaluated operating parameters of the fuel cell unit, which are caused, for example, by a load change, are not perceived or are taken as disturbances. In part, and to reduce these disadvantages somewhat, a comparatively large number of operating parameters is measured and evaluated in these systems which, in turn, disadvantageously changes the complexity thereof.

### SUMMARY OF THE INVENTION

It is an object of the invention to provide a fuel cell system which makes possible an almost complete monitoring of the internal operating state of the fuel cell unit. It is a further object of the invention to reduce the number of utilized sensors and thereby the complexity of the system.

The fuel cell system of the invention includes: a fuel preparation unit; a fuel cell unit connected to the fuel preparation unit; the fuel cell unit having a first operating parameter and the fuel cell system having a second operating parameter which changes in a known manner as a function of time; a measuring unit for measuring at least the first operating parameter; and, an evaluation unit incorporating the measuring unit and being configured to evaluate a time-dependent change of the first operating parameter in dependence upon the time-dependent change of the second operating parameter.

In view of the above, the fuel cell system according to the invention is characterized in that an evaluation unit is provided for evaluating a time-dependent change of the first operating parameter of the fuel cell unit in dependence upon a known time-dependent change of at least a second operating parameter of the fuel cell system.

In accordance with the invention, the corresponding electronic components, such as resistors and capacitors (which correlate with electrochemical processes in the electrochemical total system), can be determined by means of a model of the electrochemical system of the fuel cell unit, that is, by means, for example, of a so-called equivalent circuit diagram so that the internal condition of the fuel cell unit can be determined. In this way, changes, for example, of the electrolyte resistance, the catalyst activity or the substance transfer can be evaluated independently of each other in an advantageous manner. No special sensor is needed in each case for the above-mentioned possible changes so that especially the complexity of monitoring the operating parameters of the internal state of the fuel cell unit is reduced.

With an evaluation unit according to the invention, a monitoring of almost all operating parameters of the internal operating state of the fuel cell unit is possible while, at the same time, reducing the number of sensors.

In fuel cell systems, which are subjected to frequent load changes (for example, in vehicles or the like), a second operating parameter of the fuel cell system is advantageously monitored and determined for a load change by means of an evaluation unit and the change of the first operating parameter of the fuel cell unit is evaluated. The second operating parameter can, for example, be a so-called load resistor. In this way, the value or trace of the time-dependent change of the second parameter of the fuel cell system (for example, the change of the load resistance) can be determined comparatively simply. A corresponding change is, if needed, realized by an actuation of an actuating element, for example, in the form of an accelerator pedal in a vehicle or the like.

In a special embodiment of the invention, a generator is provided for generating a known, time-dependent change of the second operating parameter of the fuel cell system. In this way, it is ensured that the inner operating parameters of the fuel cell unit can be checked for all operating states of the fuel cell system, that is, also for a static use. Thus, and in an advantageous manner, a comparatively low and/or continuous change or a change of long duration as well as a comparatively intense and/or pulse-like change of the second operating parameter of the fuel cell system is realizable.

Advantageously, the generator is provided at least for generating a change of an electrochemical operating parameter of the fuel cell system such as the operating voltage or the operating current or the like. The change caused by the generator is here comparatively small so that the operation of the fuel cell system is not disadvantageously influenced. With this measure, an electrical monitoring of the fuel cell system is ensured in an advantageous manner.

In a further embodiment of the invention, the generator is provided at least for generating a change of a non-electrical operating parameter of the fuel cell system, such as the pressure, temperature, humidity or the composition of the educts.

Preferably, the known, time-dependent change of at least the second operating parameter of the fuel cell system is offset in time to a measuring phase of the first operating parameter of the fuel cell unit which follows or, alternatively, takes place simultaneously herewith. This last situation means that the known time-dependent change of an operating parameter such as an alternating current voltage having a known frequency is modulated, if required, on the corresponding operating parameter such as the operating voltage.

In a further embodiment of the invention, the evaluation unit is configured for comparing the time-dependent change of the first operating parameter of the fuel cell unit to a desired change of the first operating parameter of the fuel cell unit. In this way, and in an advantageous manner, a diagnosis of the internal operating state of the fuel cell unit can be realized. Accordingly, a control of the fuel cell system is preferably realizable wherein short-term exceeding of the corresponding operating parameter such as of the fuel preparation unit can be tolerated without the operating parameters of the fuel unit being disadvantageously changed. This leads to the situation that disturbances, which change the time-dependent change of the first operating parameter of the fuel cell unit only within a pregiven fluctuation width, need not be eliminated. This operates in an advantageous manner on the design of the fuel cell unit and to a special degree on the design of the fuel cell preparation unit. For example, short-term small disturbances as they often occur in present-day fuel cell preparation units need not be compensated. Advantageously, a complex monitoring or suppression including initiating and converting necessary countermeasures of corresponding disturbances can be dropped which operates positively on the design of the most different components of the fuel cell system.

Preferably, the evaluation unit includes at least a filter device for separating the change of the first parameter of the fuel cell unit from changes of other operating parameters of the fuel cell system. The change of the first operating parameter can be caused by the change of the second operating parameter of the fuel cell system. For periodic changes, this filter can, for example, be configured as a lock-in amplifier. In this way, it is ensured in an advantageous manner that the change of the first operating parameter can be determined even when, for example, a disturbance occurs in the fuel preparation unit at the sane time. The change of the first operating parameter is caused by the known, time-dependent change of the second operating parameter of the fuel cell system. Distinguishing between signal performance and noise performance is clearly improved especially by the filter device.

According to the invention, a pressure oscillation of an educt flow having a defined frequency spectrum can be filtered from the current signal or voltage signal of the fuel cell unit, if required, by a lock-in amplification. Only the frequencies of the measurement signal, that is, of the pressure oscillation, are used advantageously for the further evaluation and control.

In a further embodiment of the invention, the evaluation unit includes at least a control unit for controlling the fuel cell unit. In this way, it is ensured in an advantageous manner that, when a disturbance of the fuel cell unit is determined, if required, measures are initiated, for example, coupling in a purifying gas such as air or the like which is introduced for oxidizing a CO-adsorption layer in the fuel cell unit so that the CO-adsorption layer is broken down and a drop in capacity of the fuel cell unit is thereby eliminated. Preferably, and in accordance with the invention, highly sensitive CO-sensors are avoided in the anode gas region as are the costs associated therewith.

In another embodiment of the invention, the evaluation unit includes at least one control unit for controlling the fuel preparation unit. With this measure, advantageous countermeasures can be initiated, for example, when determining a deviation of the time-dependent change of the first operating parameter of the fuel cell unit, with a corresponding desired change and a localized disturbance caused thereby within the fuel preparation unit. These countermeasures change the operating conditions of the fuel preparation unit, for example, by means of actuating valves, heating corresponding components, metering additional operating substances or the like.

Preferably, the evaluation unit includes a recording unit for recording the time-dependent trace of at least one operating parameter so that, for example, an advantageous control of the fuel cell system can be realized by means of a stored characteristic line field or an integrated expert system or the like.

In a preferred manner, the control of the fuel cell system is achieved in the form of fixed program control rules, via an adaptive strategy or the like. If required, the evaluation unit operates with a fuzzy logic. In this way, an advantageous diagnosis and control can be realized.

In a special further embodiment of the invention, the evaluation unit includes a device for the external definition of the operating state of the fuel cell system, for example, for visualizing the operating state for the user or for the technical monitoring personnel. Accordingly, the maintenance and repair of the fuel cell system of the invention is improved in an advantageous manner because the system can record or bring to protocol the trace of the operating parameters for this application purpose. A conclusion as to possible defective or worn components of the fuel cell system can be made, if required, from the time-dependent trace of the operating parameters or of the operating state.

According to the invention, disturbances which cannot be eliminated by a change of the operating parameters such as, for example, the detection of a leak, can lead to the condition that the defective fuel cell unit or fuel cell is transferred into a reliable operating state. The total system can be operated in this way in the best possible manner in an association with further fuel cell units or other fuel cells or other current generators.

### BRIEF DESCRIPTION OF THE DRAWINGS

The invention will now be described with reference to the drawings wherein:

FIG. 1 shows a schematic coupling of an impedance system to a fuel cell unit according to the invention; and,

FIG. 2 shows a schematic coupling of a further impedance system to a fuel cell unit in accordance with the invention.

### DESCRIPTION OF THE PREFERRED EMBODIMENTS OF THE INVENTION

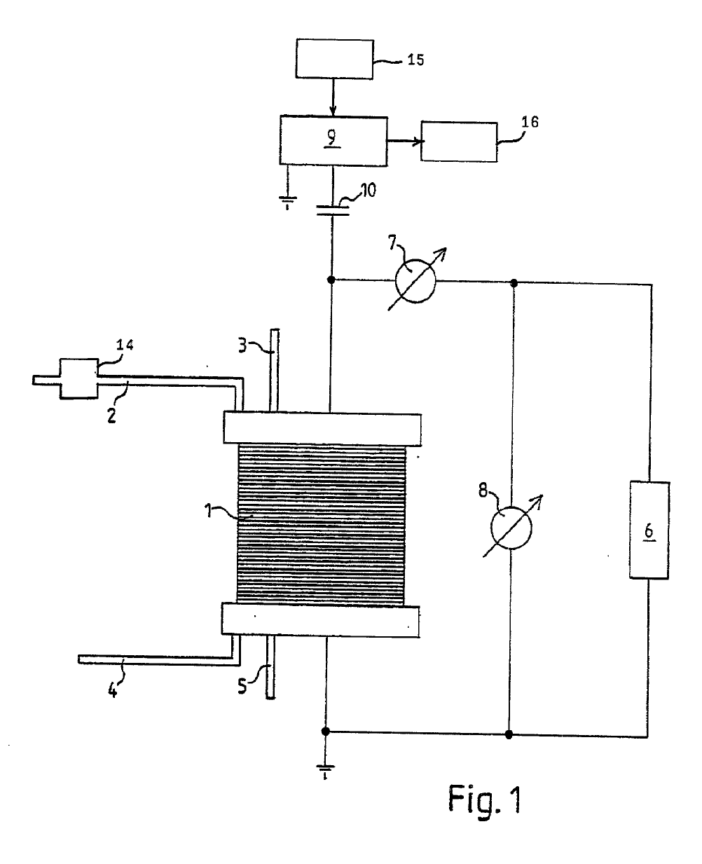

In FIG. 1, a fuel cell system is shown incorporating a fuel cell unit 1 and a fuel preparation unit 14. The fuel cell unit 1 has an anode gas supply 2, an anode exhaust-gas line 3 as well as a cathode gas supply 4 and a cathode exhaust-gas line 5. An electrical consumer 6 is shown as a load resistor 6. Furthermore, a current measuring device 7 as well as a voltage measuring device 8 for measuring a corresponding operating parameters of the fuel cell unit 1 are shown.

The embodiment of FIG. 1 is based on the use of the impedance spectroscopy by means of a capacitive coupling 10 of an impedance device 9. An inductive coupling can also be realized.

The impedance device 9 can include a filter for separating a change of a first operating parameter of the fuel cell unit 1 from changes of other operating parameters of the fuel cell system. The change of this first operating parameter is caused by a charge of a second operating parameter with this second operating parameter being of the fuel cell system.

It is known that the frequency-dependent impedance of fuel cell units 1 can be modeled with electrotechnical equivalent circuit diagrams. The equivalent circuit diagram comprises a network of ohmic, capacitive and inductive impedances as well as further complex impedances which describe, for example, the substance transfer or the catalyst deactivation. Frequently, the values of the impedance network are adapted with measurement data of the impedance spectrum. The values determined in this way represent by way of a model the internal operating state of the fuel cell unit 1.

According to the invention, for example, for several (for example, ten) different frequencies, an alternating voltage is superposed or impressed on the voltage of the fuel cell unit 1. According to the invention, the corresponding current response is recorded by means of the current device 7. Here, the measurement operation can take place either sequentially or also simultaneously by using a corresponding filter (for example, a lock-in amplifier) by superposing the operating signal on the measurement signals.

The complex-value impedance for the selected frequencies can be determined from the relationship of the current response to the excitation voltage signal. The values of the resistance network of the fuel cell unit 1 are computed from the set of data obtained in this way. Thereafter, these values are interpreted, that is, the resistance values are disposed in narrowly limited parameter intervals in dependence upon the operating state of the fuel cell unit 1 and exceeding the parameter limits points to a non-optimal or defective operating state of the fuel cell unit 1 which can be identified hereby.

If reqluired, and with the aid of a measure matrix, which is to be defined, corresponding countermeasures can be taken. If, for example, the value, which corresponds in the impedance network to the ohmic electrolyte impedance, exceeds a certain threshold value, then this defines an indication as to a defective wetting of the membrane. Correspondingly and if required, a humidifier (not shown) changes the humidity of the educt flows. A system, which operates with a measure matrix, can be identified also as a so-called “expert system”. This system, for example, defines a set of impedance values as “good” and initiates corresponding countermeasures when pregiven values of the operating parameters are exceeded.

The use of an impedance network as a mediating abstraction level can be omitted in a further possible embodiment of the invention. This is permissible because there is a functional relationship between the determined impedance values and the values of the impedance network as well as a relationship between the values of the impedance network and the countermeasures to be initiated so that these images can be interlinked with each other.

Furthermore, and in a special embodiment, the in-coupling of an analysis signal can be omitted because, in electrochemical systems, fluctuations in the current and in the voltage occur, that is, a so-called electrochemical noise. These fluctuations can be set into relationship with each other whereby a good approximation for the frequency-dependent amount of the impedance can be obtained. These values can be applied to the control of the fuel cell system in correspondence to the above descriptions.

Basically, the time-dependent change of an electrochemical operating parameter can be converted into a frequency-dependent presentation via a Fourier transformation. The current as well as the voltage of the system reacts at the same time to the change of the electrochemical parameter. For this reason, the reaction of the system can be analyzed and evaluated in the frequency domain in the same way as set forth above via a second Fourier transformation whereby corresponding countermeasures can be initiated.

Furthermore, the possibility is also present to transfer the time behavior of the observed operating parameter directly into a functional description and to use the functional operating parameters, which are obtained from the adaptation of the values of the equivalent circuit diagram, as a starting point for an operating condition analysis of the fuel cell unit. Thus, it is, for example, known that, for a potentiostatic voltage jump, the current response is determined in the first milliseconds by the change of the double-layer capacitance of the fuel cell unit 1. Over longer times, the time behavior is determined by the diffusion processes. If, for example, for a voltage jump in an increasing direction, a low rate of change of the current intensity is determined in the time interval from 50 milliseconds to 1 second, then this is an indication of an obstructed or impeded substance transfer in the fuel cell unit 1. If required, in combination with other measurement values such as the temperature of the fuel cell unit, the pressure of the educts or the like, the diagnosis could therefore be, for example, a flooding of the pore structure because of an entry of water which is too high. Possible countermeasures would be the reduction of the wetting or the increase of the temperature of the fuel cell unit 1. The latter leads to a more intense discharge of water from the fuel cell unit 1 as a consequence of evaporation.

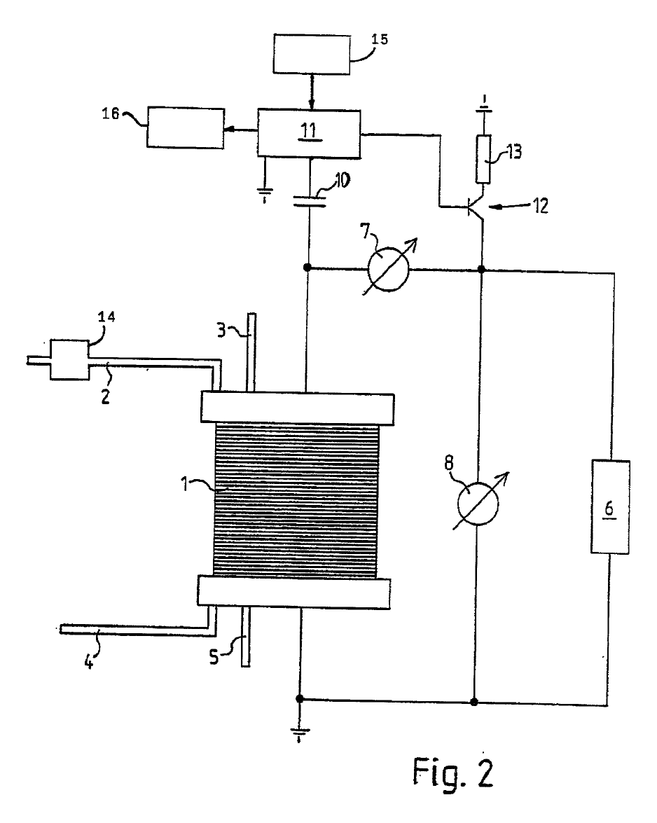

A corresponding analysis of comparatively large changes of the operating parameters of the fuel cell unit 1 is, for example, realizable by means of the arrangement shown in FIG. 2. For example, a comparatively large jump-like change of the current of the fuel cell unit 1 can be undertaken (galvanostatic jump) by the in-coupling of a bypass resistor 13 by means of a control device 11 and a transistor 12. A conclusion can, in turn, be drawn as to the operating condition of the fuel cell unit 1 from the analysis of the time-dependent trace of the cell voltage. Here, a corresponding control system should ensure that the external function of the fuel cell unit is not affected. Correspondingly large changes of an operating parameter should therefore not be carried out at full-load operation.

According to the invention, a fuel cell unit 1 is characterized under different load conditions with respect to its time behavior. The set of parameters obtained in this way are stored in a data bank. In this way, it is ensured that, during operation, deviations from the ideal state are selected via the observation of the load change performance. The determined load change performance is compared to the stored values. For example, by a comparison to known patterns, that is, by means of a so-called pattern matching or by means of a functional analysis, it can be determined whether the determined performance corresponds to a proper condition of the fuel cell unit 1 or in which direction the operating state has distanced itself from the desired state. This procedure is especially advantageous for highly dynamic systems wherein load changes occur often such as in a vehicle.

The measuring devices 7 and 8 and the impedance device 9 conjointly define an evaluation device. This evaluation device (7, 8, 9) can include a recording device 16 for recording the time-dependent course of at least one of the operating parameters.

In summary, the fuel cell system described above includes the duel preparation unit 14 and the fuel cell unit 1. The fuel cell unit 1 has a first operating parameter and the fuel cell system has a second operating parameter which changes in a known manner as a function of time. The measuring unit (7, 8) measures the first operating parameter. The evaluation unit (7, 8, 9) is configured to evaluate a time-dependent change of the first operating parameter in dependence upon the time-dependent change of the second operating parameter.

A generator 15 can be connected to the impedance device 9 for generating the known change of the second operating parameter as a function of time.

It is understood that the foregoing description is that of the preferred embodiments of the invention and that various changes and modifications may be made thereto without departing from the spirit and scope of the invention as defined in the appended claims.

What is claimed is:

1. A fuel cell system comprising:
a fuel preparation unit;
a fuel cell unit connected to said fuel preparation unit;
said fuel cell unit having a first operating parameter and said fuel cell system having a second operating parameter which changes in a known manner as a function of time;
a measuring unit for measuring at least said first operating parameter; and,
an evaluation unit incorporating said measuring unit and being configured to evaluate a time-dependent change of said first operating parameter in dependence upon the time-dependent change of said second operating parameter.

2. The fuel cell system of claim 1, further comprising a generator for generating the known change of said second operating parameter as a function of time.

3. The fuel cell system of claim 1, wherein said second operating parameter is an electrochemical operating parameter of said fuel cell system; and, wherein said fuel cell system further comprises a generator for generating the known change of said second operating parameter as a function of time.

4. The fuel cell system of claim 1, wherein said second operating parameter is a non-electrical operating parameter of said fuel cell system; and, wherein said fuel cell system further comprises a generator for generating the known change of said second operating parameter as a function of time.

5. The fuel cell system of claim 1, wherein said evaluation unit is configured to compare a time-dependent change of said first operating parameter to a desired change of said first operating parameter.

6. The fuel cell system of claim 1, wherein a change of said second operating parameter causes a change of said first operating parameter; and, wherein said evaluation unit further comprises a filter device for separating said change of said first operating parameter from changes of other operating parameters of said fuel cell system.

7. The fuel cell system of claim 1, wherein said evaluation unit includes at least one control unit for controlling said fuel cell unit.

8. The fuel cell system of claim 1, wherein said evaluation unit includes a control unit for controlling said fuel preparation unit.

9. The fuel cell system of claim 1, wherein said evaluation unit includes a recording device for recording the time-dependent trace of at least one of said operating parameters.

10. A motor vehicle comprising:
a fuel cell system incorporating a fuel preparation unit and a fuel cell unit connected to said fuel preparation unit;
said fuel cell unit having a first operating parameter and said fuel cell system having a second operating parameter which changes in a known manner as a function of time;
a measuring unit for measuring at least said first operating parameter; and,
an evaluation unit incorporating said measuring unit and being configured to evaluate a time-dependent change of said first operating parameter in dependence upon the time-dependent change of said second operating parameter.

11. A generator system comprising;
a fuel preparation unit;
a fuel cell unit connected to said fuel preparation unit;
said fuel cell unit having a first operating parameter and said fuel cell system having a second operating parameter which changes in a known manner as a function of time;
a measuring unit for measuring at least said first operating parameter; and,
an evaluation unit incorporating said measuring unit and being configured to evaluate a time-dependent change of said first operating parameter in dependence upon the time-dependent change of said second operating parameter.
